(19) United States
(12) Patent Application Publication
(10) Pub. No.: US 2011/0209583 A1
(43) Pub. Date: Sep. 1, 2011

(54) RATCHET FLARE NUT WRENCH

(75) Inventor: Chih-Ching HSIEH, TAICHUNG COUNTY (TW)

(73) Assignee: Chih-Ching HSIEH, TAICHUNG COUNTY (TW)

(21) Appl. No.: 12/780,853

(22) Filed: May 14, 2010

(30) Foreign Application Priority Data
Feb. 26, 2010 (TW) 99105792

(51) Int. Cl. B25B 13/50; B25B 13/06; B25B 13/46

(52) U.S. Cl. 81/58.2; 81/60; 81/124.2

(57) ABSTRACT

A ratchet flare nut wrench is disclosed. The ratchet flare nut wrench includes a handle, a socket, and a ratchet. The handle includes at least one open end. The socket includes a through hole therein, wherein the through hole has different sizes on opposite sides of the socket. The ratchet connects the socket to the open end of the handle.

### RELATED APPLICATIONS

The application claims priority to Taiwan Application Serial Number 99105792, filed Feb. 26, 2010, which is herein incorporated by reference.

### BACKGROUND

1. Technical Field

The present disclosure relates to wrenches. More particularly, the present disclosure relates to ratchet flare nut wrenches.

2. Description of Related Art

A wrench or spanner is a tool used to provide grip and mechanical advantage in applying torque to turn threaded fasteners, such as nuts and bolts. Flare nut wrench is one kind of the wrench for gripping the nuts on the ends of tubes. More particularly, the flare nut wrench has a narrow opening just wide enough to allow the wrench to fit over the tube.

### SUMMARY

According to one embodiment of the present disclosure, a ratchet flare nut wrench includes a handle, a socket, and a ratchet. The handle includes at least one open end. The socket includes a through hole therein, wherein the through hole has different sizes on opposite sides of the socket. The ratchet connects the socket to the open end of the handle.

According to another embodiment of the present disclosure, a ratchet flare nut wrench includes a handle, a socket, a stopper, and a ratchet. The handle includes at least one open end. The socket includes a through hole therein for engaging a threaded fastener. The stopper protrudes from the inner surface of the socket. The ratchet connects the socket to the open end of the handle.

According to yet another embodiment of the present disclosure, a ratchet flare nut wrench includes a handle, a socket, a ratchet, and a C-shaped ring. The handle includes at least one open end. The socket includes a through hole therein, wherein the through hole has different sizes on opposite sides of the socket. The ratchet connects the socket to the open end of the handle. The C-shaped ring is rotatably disposed on the socket for closing at least one part of the opening of the socket.

### BRIEF DESCRIPTION OF THE DRAWINGS

FIG. 1 is a three-dimensional view of a ratchet flare nut wrench according to one embodiment of the present disclosure.

FIG. 2 is an exploded view of the ratchet flare nut wrench of FIG. 1.

FIG. 3 is a three-dimensional view of the ratchet flare nut wrench of FIG. 1, showing that the ratchet flare nut wrench fits over a tube.

FIG. 4 is a three-dimensional view of the ratchet flare nut wrench of FIG. 1, showing that the ratchet flare nut wrench grips a threaded nut.

FIG. 5 is a cross-sectional view taken along line 5-5 of FIG. 4.

FIG. 6 is a three-dimensional view of the ratchet flare nut wrench of FIG. 1 in one operating mode.

FIG. 7 is a cross-sectional view taken along line 7-7 of FIG. 1.

FIG. 8 is a cross-sectional view of the ratchet flare nut wrench of FIG. 7 in one operating mode.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

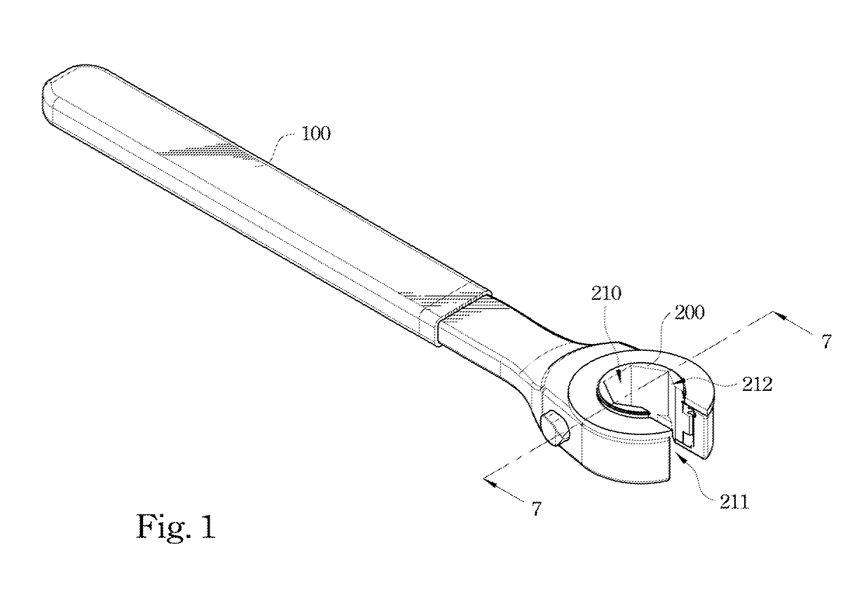

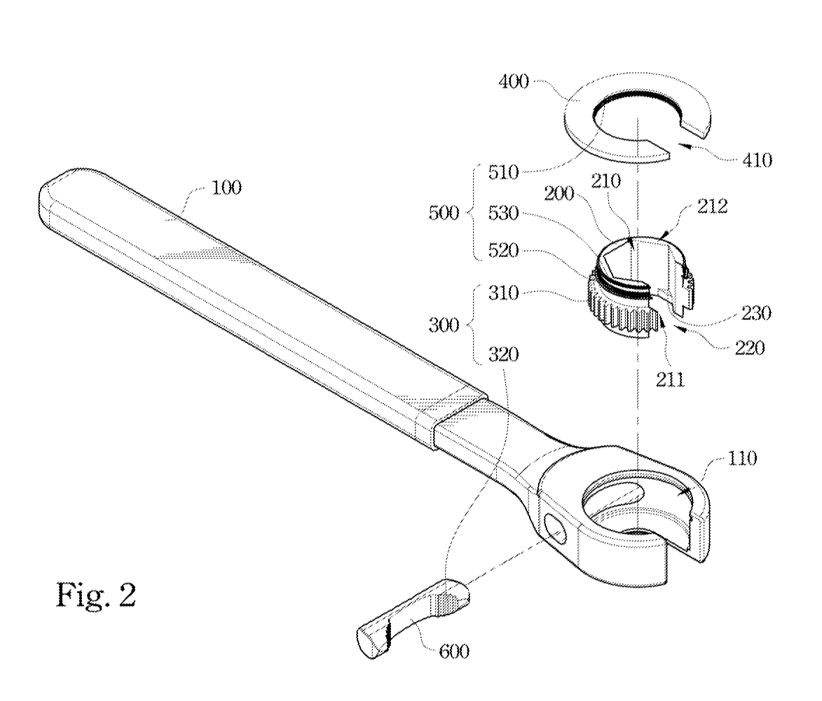

FIG. 1 is a three-dimensional view of a ratchet flare nut wrench according to one embodiment of the present disclosure. FIG. 2 is an exploded view of the ratchet flare nut wrench of FIG. 1. The ratchet flare nut wrench includes a handle 100, a socket 200, and a ratchet 300. The handle 100 includes at least one open end 110. The socket 200 includes a through hole 210 therein. The ratchet 300 connects the socket 200 to the open end 110 of the handle 100.

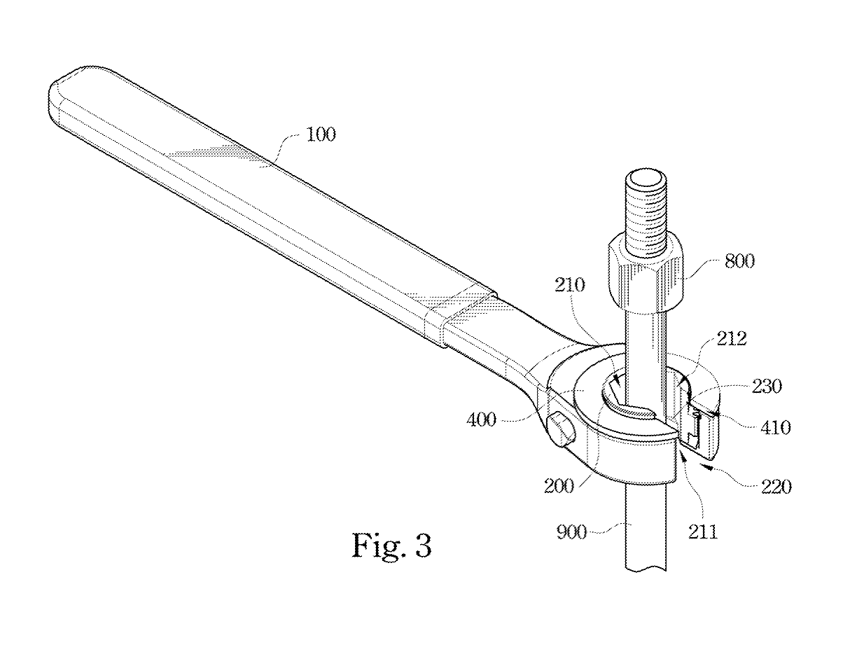

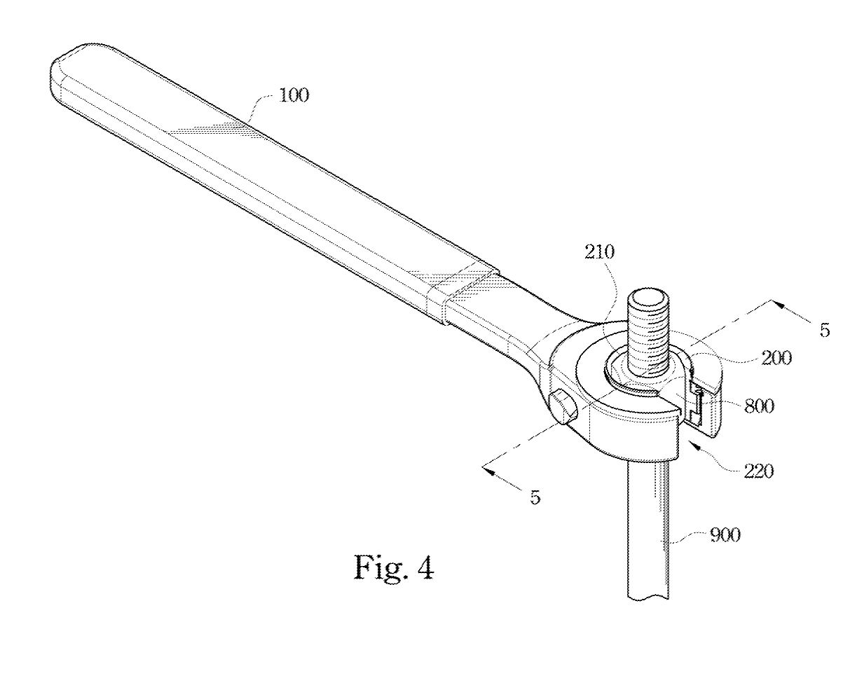

FIG. 3 is a three-dimensional view of the ratchet flare nut wrench of FIG. 1, showing that the ratchet flare nut wrench fits over a tube 900. In use, the user fits the through hole 210 of the socket 200 over the tube 900 and moves the ratchet flare nut wrench toward a threaded fastener 800 of the tube 900. FIG. 4 is a three-dimensional view of the ratchet flare nut wrench of FIG. 1, showing that the ratchet flare nut wrench grips the threaded fastener 800. The user moves the socket 200 to grip the threaded fastener 800, and the user can rotate the ratchet flare nut wrench to fasten or loosen the threaded fastener 800.

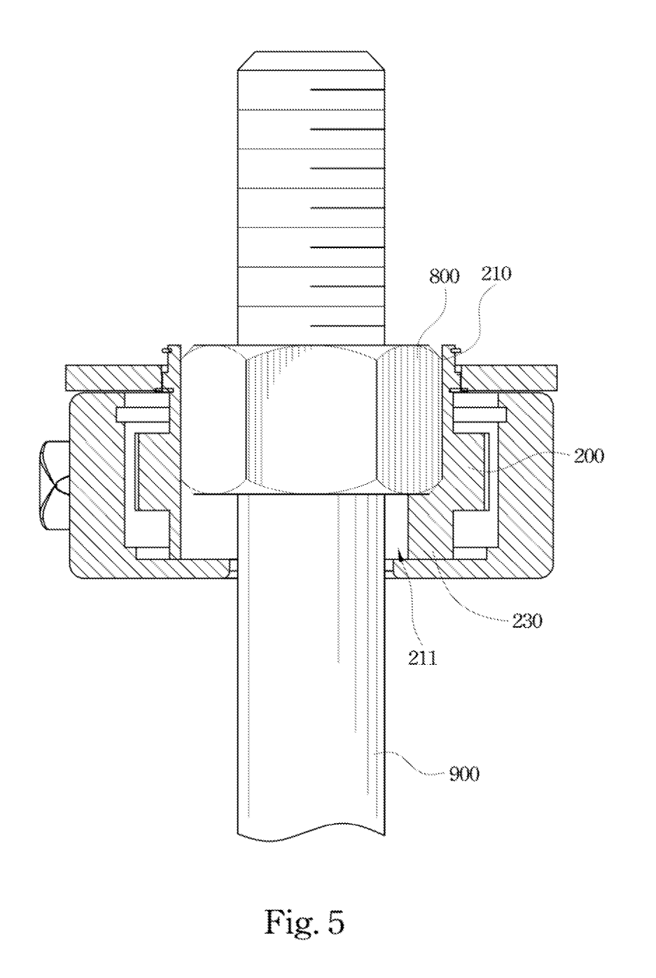

More specifically, the through hole 210 has different sizes on opposite sides of the socket 200. FIG. 5 is a cross-sectional view taken along line 5-5 of FIG. 4. The socket 200 is set on the threaded fastener 800 from the larger side of the through hole 210, and the smaller side of the through hole 210 can restrain the threaded fastener 800 from passing through the through hole 210.

Specifically, the ratchet flare nut wrench has a stopper 230, and the stopper 230 protrudes from the inner surface of the socket 200. When the user sets the socket 200 on the threaded fastener 800, the stopper 230 can restrain the threaded fastener 800 from passing through the through hole 210. In addition, the stopper 230 can make one side of the through hole 210 smaller than the other for restraining the threaded fastener 800.

Return to FIG. 2. More particularly, the through hole 210 of the socket 200 is polygonal, and the stopper 230 is located at one corner of the through hole 210. In use, the stopper 230 can resist larger shearing stress of the threaded fastener 800 when the stopper 230 is located at the corner.

In detail, the socket 200 has an opening 220 in the side wall of the socket 200, and the opening 220 is connected to the through hole 210. With references to FIG. 3, the tube 900 passes through the opening 220 of the socket 200 first, and then the through hole 210 of the socket 200 can be fit over the tube 900. With references to FIG. 4, the distance of the opening 220 is smaller than the width of the threaded fastener 800. In other words, the distance of the opening 220 is smaller than the diameter of the through hole 210. Therefore, the threaded fastener 800 can't leave the through hole 210 from the opening 220.

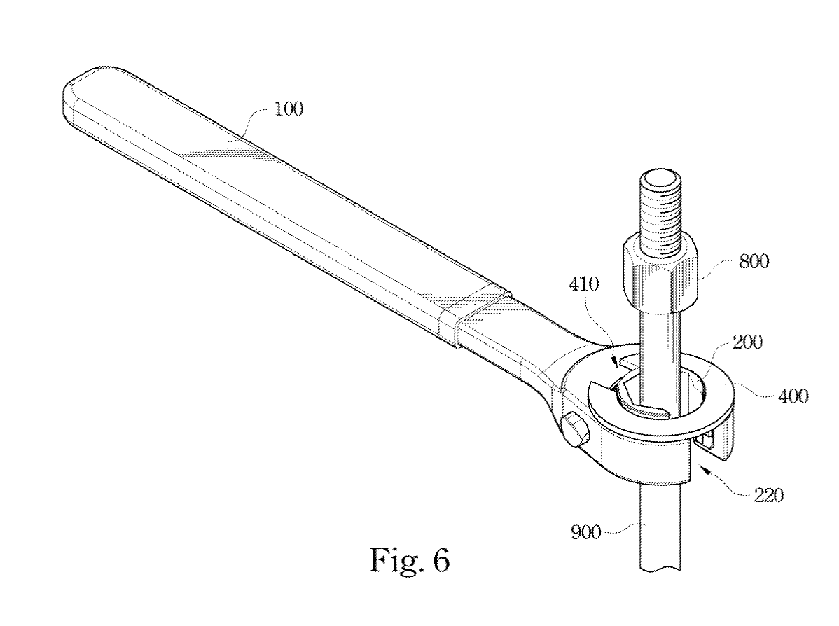

FIG. 6 is a three-dimensional view of the ratchet flare nut wrench of FIG. 1 in one operating mode. The ratchet flare nut wrench further includes a C-shaped ring 400.' The C-shaped ring 400 is rotatably disposed on the socket 200. In use, rotating the C-shaped ring 400 while the socket 200 fitting over s the tube 900, the C-shaped ring 400 can close at least one part of the opening 220 of the socket 200 and restrain the tube 900 in the socket 200.

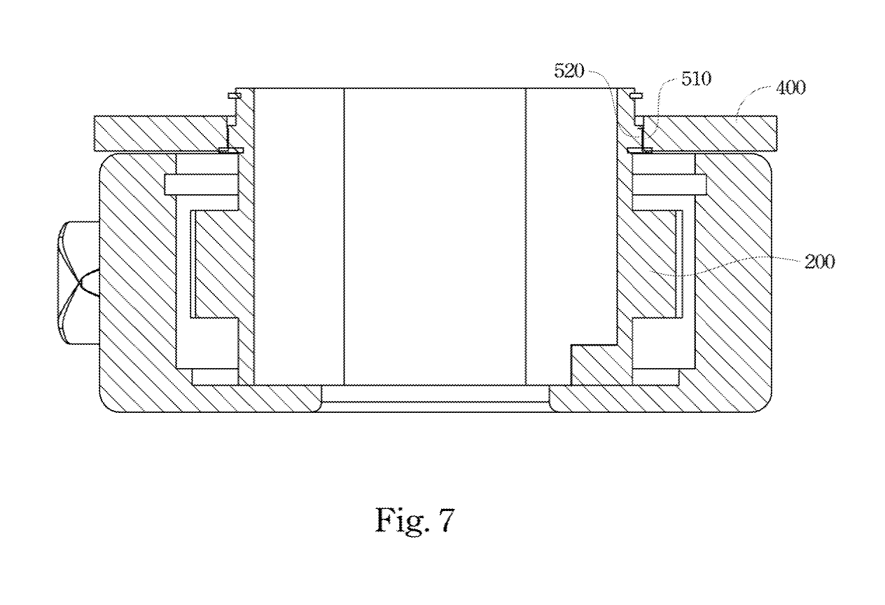

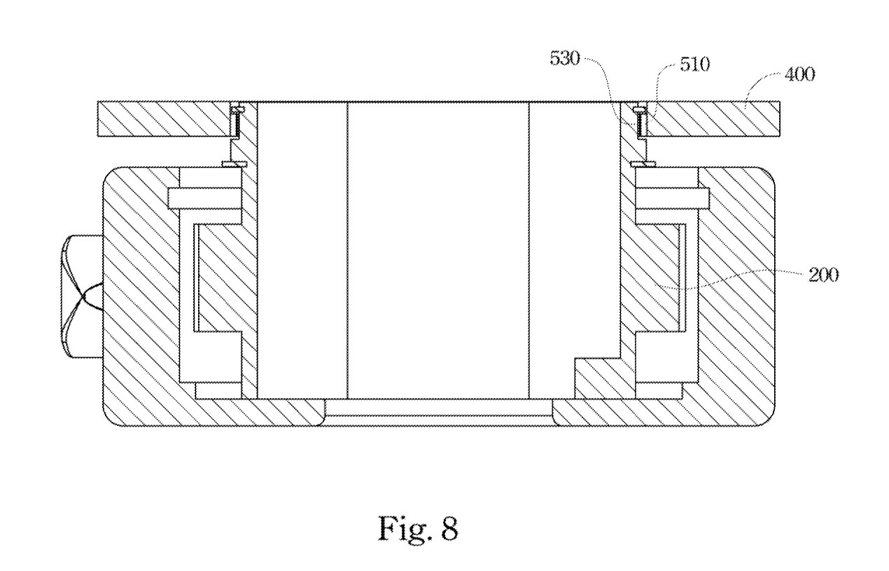

Return to FIG. 2, the ratchet flare nut wrench further includes an attaching set 500. The attaching set 500 includes at least two teeth 510, 520 and at least one groove 530. The tooth 510 is disposed on the inner surface of the C-shaped ring 400, and the other tooth 520 and the groove 530 are disposed on the outer surface of the socket 200 respectively. FIG. 7 is a cross-sectional view taken along line 7-7 of FIG. 1. When the tooth 510 engages with the tooth 520, the C-shaped ring 400 is linked to the socket 200 and rotates together. FIG. 8 is a cross-sectional view of the ratchet flare nut wrench of FIG. 7 in one operating mode. When the user pushes the C-shaped ring 400, the tooth 510 disposed on the C-shaped ring 400 is disengaged with the tooth 520 disposed on the socket 200, and the tooth 510 is contained in the groove 530. Therefore, the C-shaped ring 400 can freely rotate about the socket 200.

Return to FIG. 2, the ratchet flare nut wrench further includes a reversing lever 600, and the ratchet 300 includes at least one tooth 310 and two pawls 320. The reversing lever 600 is movably disposed on the handle 100. The tooth 310 is disposed on the socket 200. The two pawls 320 are disposed on two ends of the reversing lever 600 respectively. Each of the two pawls 320 restrains the socket 200 from rotating in only one direction by engaging with the tooth 310 disposed on the socket 200. Therefore, the reversing lever 600 can change the rotating direction of the socket 200 by switching the two pawls 320 to engage with the tooth 310.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A ratchet flare nut wrench comprising:
a handle comprising at least one open end;
a socket comprising a through hole therein, wherein the through hole has different sizes on opposite sides of the socket; and
a ratchet connecting the socket to the open end of the handle.

2. The ratchet flare nut wrench of claim 1, further comprising:
at least one stopper protruding from the inner surface of the socket.

3. The ratchet flare nut wrench of claim 1, further comprising:
at least one stopper, wherein the through hole of the socket is polygonal, and the stopper is located at one corner of the through hole of the socket.

4. A ratchet flare nut wrench comprising:
a handle comprising at least one open end;
a socket comprising a through hole therein for engaging a threaded fastener;
a stopper protruding from the inner surface of the socket; and
a ratchet connecting the socket to the open end of the handle.

5. The ratchet flare nut wrench of claim 4, wherein the through hole of the socket is polygonal, and the stopper is located at one corner of the through hole of the socket.

6. The ratchet flare nut wrench of claim 4, wherein the socket has an opening in the side wall of the socket, and the opening is connected to the through hole.

7. The ratchet flare nut wrench of claim 6, further comprising:
a C-shaped ring rotatably disposed on the socket for closing at least one part of the opening of the socket.

8. A ratchet flare nut wrench comprising:
a handle comprising at least one open end;
a socket comprising a through hole therein, wherein the through hole has different sizes on opposite sides of the socket;
a ratchet connecting the socket to the open end of the handle; and
a C-shaped ring rotatably disposed on the socket for closing at least one part of the opening of the socket.

9. The ratchet flare nut wrench of claim 8, further comprising:
at least one stopper protruding from the inner surface of the socket.

10. The ratchet flare nut wrench of claim 8, further comprising:
at least one stopper, wherein the through hole of the socket is polygonal, and the stopper is located at one corner of the through hole of the socket.
